(19) United States
(12) Patent Application Publication
(10) Pub. No.: US 2014/0120503 A1
(43) Pub. Date: May 1, 2014

(54) METHOD, APPARATUS AND SYSTEM PLATFORM OF DUAL LANGUAGE ELECTRONIC BOOK FILE GENERATION

(71) Applicants: Andrew Nicol, New York, NY (US); Gabriel Salinas, Houston, TX (US)

(72) Inventors: Andrew Nicol, New York, NY (US); Gabriel Salinas, Houston, TX (US)

(21) Appl. No.: 14/063,426

(22) Filed: Oct. 25, 2013

Related U.S. Application Data
(60) Provisional application No. 61/718,289, filed on Oct. 25, 2012.

(51) Int. Cl. G09B 5/02; G06F 17/28; G06F 17/21

(52) U.S. Cl. CPC G09B 5/02; G06F 17/21; G06F 17/28
USPC 434/157

(57) ABSTRACT

The system platform and methods of the present disclosure brings the dual language concept to electronic books in a manner enhanced for both visual and aural learners. A method can include creating a correspondence between a first language text and a second language text. The method can include creating a correspondence between the first language text and an audio recording of the first language text. The method can include generating a dual language electronic book file comprising the first language text, the second language text, the correspondence between the first language text and the second language text, and the correspondence between the first language text and the audio recording of the first language text. An application for electronic book reading devices displays the text while playing the audio recording, maximizing the number of fragments of the first and second language texts based on one or more display variables.

### CROSS REFERENCE TO RELATED APPLICATIONS

This application claims the benefit of U.S. Provisional Application No. 61/718,289, filed Oct. 25, 2012.

### BACKGROUND

The present disclosure relates to generating dual language electronic book files for educational purposes, and software for using, displaying, and playing dual language electronic book files on tablet computers, desktop/laptop computers and/or eReader devices.

One way of learning a foreign language is reading a parallel text or “dual language” book, which has a foreign language text on one side of the book, and the reader's native language on the facing page, allowing the reader to check their reading comprehension with the text in his or her native language. Dual language books may enable readers to learn to read in their foreign language of choice without losing out on the pleasure of the reading experience by the need to frequently stop and take a look at a dictionary for new words. Furthermore, dual language books may help readers to learn previously unknown words and terminology in context in actual sentences, decreasing the need to perform monotonous vocabulary drills. A foreign language teaching aid and method are disclosed in U.S. Pat. No. 5,486,111 to Watkins. Various methods and apparatus for machine translation are described, for example, in U.S. Pat. No. 7,877,251, U.S. Pat. No. 8,249,855, U.S. Pat. No. 8,209,165, U.S. Pat. No. 6,598,015, and U.S. Patent Publication 2011/0046940.

Electronic distribution of information has gained in importance with the proliferation of personal computers and has undergone a tremendous upsurge in popularity as the Internet has become widely available. With the widespread use of the Internet, it has become possible to distribute large, coherent units of information, such as books, using electronic technologies. Books distributed using electronic technologies are commonly referred to as electronic books (“eBooks”). Various entities make eBooks available for download over ordinary Internet connections, such as broadband and dialup connections.

eBook reader devices mimic the experience of reading a conventional paper book through display of electronic information on one or more electronic displays. One type of eBook reader device is a handheld digital device having a liquid crystal display panel and enough memory and processing capability to store several eBooks. Such a device is capable of retrieving and displaying an eBook or portion of an eBook for reading.

There are some advantages to using an eBook reader device over conventional paper books. An eBook reader device is often capable of storing a number of complete unabridged eBooks. Therefore, an eBook reader containing a number of stored eBooks weighs significantly less than the same number of paper books. This makes an eBook reader a particularly attractive alternative to paper books for travel, educational purposes, and professional business use. Also, because eBooks do not require the use of paper products, they are generally offered at a lower price than their paper book counterparts. Furthermore, the use of eBook reader devices in conjunction with eBooks may be beneficial to the ecosystem, by reducing a number of books produced using paper products.

One possible implementation of an electronic book reading device is a handheld portable eBook reader device, the housing and hardware of which is described in full in U.S. Pat. No. 8,286,885, hereby incorporated by reference in its entirety.

An eBook reader device has various internal components, including system storage and a processing unit, which facilitate operation of the eBook reader device. An eBook reader device may store eBooks and other content, as well as software programs or other executable modules that may be executed by the processing unit. Examples of such programs or modules might include reader programs/applications, control modules (e.g., power management), network connection software, operating models, display drivers, sensor algorithms, page turn detectors, and the like. Examples of eBook reader devices include, for example, the Nook™ commercially available from Barnes and Noble, and the Kindle™ commercially available from Amazon.

Alternatively, a touch-screen tablet computer implementation equivalent of the above is also well known, as described in various patents, including for example, but not limited to, U.S. Pat. Nos. 8,451,238 and 8,471,824. An illustrative tablet computer hardware configuration is described in full with respect to FIGS. 1A, 1B and 2 in U.S. Pat. No. 7,479,949. As is well known, a tablet computer, such as an iPad™, a tablet running the Google™ Android™ operating system, or other portable computing device, can store and execute a variety of applications, referred to as “apps.” As referred to herein, an electronic book reading device includes tablet, laptop, or desktop computers running one or more applications capable of displaying an eBook, as well as other eBook reader devices as described above.

### SUMMARY

In at least one aspect, the disclosure relates to a dual language electronic book system platform. The system platform can include an input module that receives a first language text, a second language text, and an audio recording of the first language text. The system platform can include a text-text correspondence module that receives the first language text and second language text from the input module and outputs a correspondence between the first language text and the second language text. The system platform can also include an audio-text correspondence module that receives the first language text and the audio recording of the first language text and outputs a correspondence between the first language text and the audio recording of the first language text.

In at least one aspect, the disclosure relates to a dual language electronic book method. The method can include creating a correspondence between a first language text and a second language text. The method can include creating a correspondence between the first language text and an audio recording of the first language text. The method can include generating a dual language electronic book file comprising the first language text, the second language text, the correspondence between the first language text and the second language text, and the correspondence between the first language text and the audio recording of the first language text.

In at least one aspect, the disclosure relates to a method for dual language electronic book education. The method includes storing a dual language electronic book file on an electronic book reading device. The dual language electronic book file includes a first language text, a second language text, a correspondence between the first language text and the second language text, and a correspondence between the first language text and an audio recording of the first language text. The method also includes displaying a first fragment of the first language text adjacent to a second fragment of second language text based on the correspondence between the first language text and the second language text while playing a third fragment of the audio recording of the first language text based on the correspondence between the first language text and the audio recording of the first language text.

In at least one aspect, the disclosure relates to an electronic book reading device. The electronic book reading device includes a communication module, a user interface/display, a speaker, an operating system, and an application. The communication module can be configured to upload a dual language electronic book file, the dual language electronic book file comprising a first language text, a second language text, a correspondence between the first language text and the second language text, and a correspondence between the first language text and an audio recording of the first language text. The user interface/display can be configured to receive from a user a display variable. The user interface/display can be configured to display the first language text and the second language text. The speaker can be configured to audibly play at least a fragment of the audio recording of the first language text. The application can be configured to, based on a display variable comprising one or more of a hardware display variable and a user-entered display variable, calculate a number of fragments of the first language text and a number of fragments of the second language text to display on the user interface/display while the speaker audibly plays at least a fragment of the audio recording of the first language text.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Embodiments of systems, apparatuses, and methods for verified data delivery in cable telemetry are described with reference to the following figures. Like numbers are used throughout the figures to reference like features and components.

FIG. 1 is a screenshot illustrating an example of a dual language electronic book in use in an electronic book reading device, the file for which is generated in accordance with an embodiment of the present disclosure, showing a Spanish language text on the left, next to English language text on the right, with the text played audibly in Spanish being visibly highlighted on the page.

FIG. 2 is a block diagram of a software dual language electronic book generator module and display.

FIG. 3 is a flowchart of a method, in accordance with the present disclosure.

FIG. 4 is a block diagram of an electronic book reading device running a dBook reader application thereon.

FIG. 5 is a flowchart of a method, in accordance with the present disclosure.

FIG. 6 is a screenshot of a library of electronic dual language texts available for reading and listening.

FIG. 7 is a screenshot of customizable options in the user interface in the library of electronic dual language texts, as shown in FIG. 6.

### DETAILED DESCRIPTION

In the following description, numerous details are set forth to provide an understanding of the present disclosure. However, it will be understood by those skilled in the art that the present disclosure may be practiced without these details and that numerous variations or modifications from the described embodiments are possible.

The present disclosure relates to methods and system platforms for generating dual language texts, or dBook files, that incorporate an audio recording of the text in the target language that plays audibly as a user follows the text in an electronic book. The methods and system platform may additionally involve displaying the dual language text, while playing the audible text, using a electronic book reading device, for example a tablet computer, such as an iPad™, a tablet running the Google™ Android™ operating system, a Nook™, Kindle™, eReader, or other portable computing device. The concepts described herein enable a dual language eBook file (referred to herein as a “dBook”) that enables a reader to simultaneously read the target language text in the language which he is learning, while viewing the translation in his native language parallel to the text in the target language, and additionally while listening to an audio recording of the target language, all in the context of an electronic book reading device. Visual and aural learners both have an enhanced learning experience, and proper pronunciation may be learned while studying grammar and vocabulary.

The final output of the generation method and system platform described herein can be referred to as a dBook that incorporates all of the information gathered: the original language text fragments, translated text fragments, the correspondence of the aforementioned, and audio timestamps for each fragment. An extract from a sample file is shown in Appendix A. The methods of the present disclosure additionally extend to displaying the electronic file dual language book (i.e., dBook) in an electronic book reading device, such as a tablet computer (ex. iPad™) or eBook reader device.

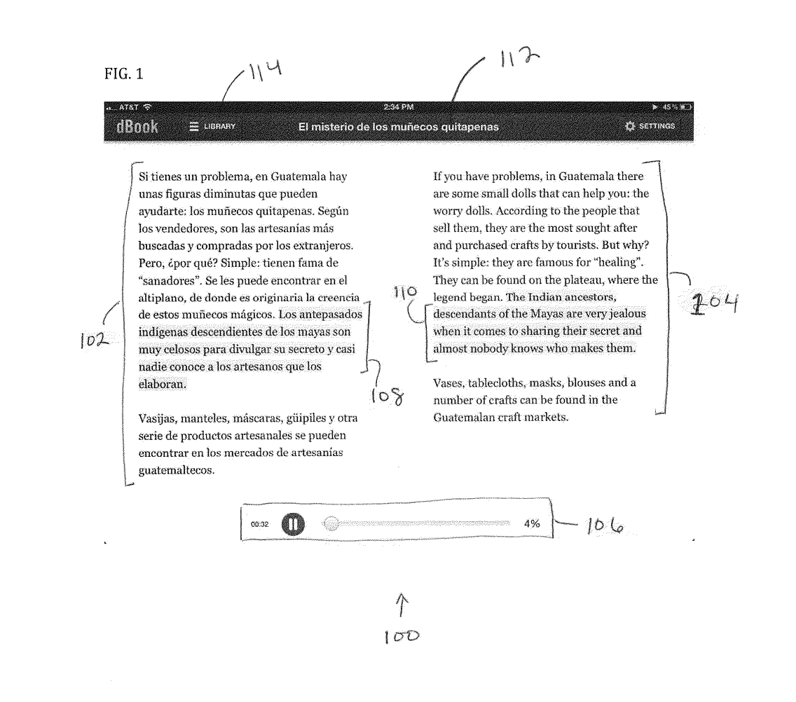

FIG. 1 is a screenshot illustrating a page 100 in an example of the dual language electronic book generated in accordance with an embodiment of the present disclosure. The page 100 illustrates a Spanish-English dual language book, wherein English is the native language of the user and Spanish is the target language of the user to be learned. The page 100 shows a portion of a Spanish language text 102 on the left, next to an English language text 104 on the right. The English language text 104 is a translation of the Spanish language text 102.

When a fragment 108 of the Spanish language text 102 is highlighted, the corresponding translated fragment 110, which may be a literal word-for-word translation or a contextual translation, in the English language text 104 is also highlighted. In an embodiment, words or phrases may remain highlighted or underlined in the text. Selecting such words or phrases may open a pop-up tooltip with additional information, such as, for example, a definition, pronunciation, or grammar explanation.

The title 112 in the target language is shown at top, in the target language, in this example, Spanish.

Also shown is an audio player bar 106 having a timer and play controls that allow the user to start, pause, play, etc., an audio recording of the Spanish language text 102. Upon activation by the user using the audio player bar 106, a recording of the fragment 108 is played audibly in Spanish while the fragment 108 is visibly highlighted on the page. Using the audio player bar 106, a user may repeat the recording of the fragment 108 as often as desired while studying the highlighted fragment 108 and the translated fragment 110. When the user navigates through the text, the position in the audio recording changes correspondingly, coordinated by the application described herein. Similarly, when the user leaves the audio playing via the audio player bar 106, the highlighting in the texts 102 and 104 may automatically progress from fragment to fragment, and the page currently being displayed will update whenever necessary to show the fragment that is being read aloud via the audio player bar 106.

A page 100 can be displayed, for example, on any implementation of an electronic book reading device. Likewise, the dual language electronic book may be displayed in a conventional computer, including desktop or laptop configurations.

Navigation from page 100 may be controlled as well known in the field, and for example, selection of another electronic dual language book file may be completed by election of the library menu 114.

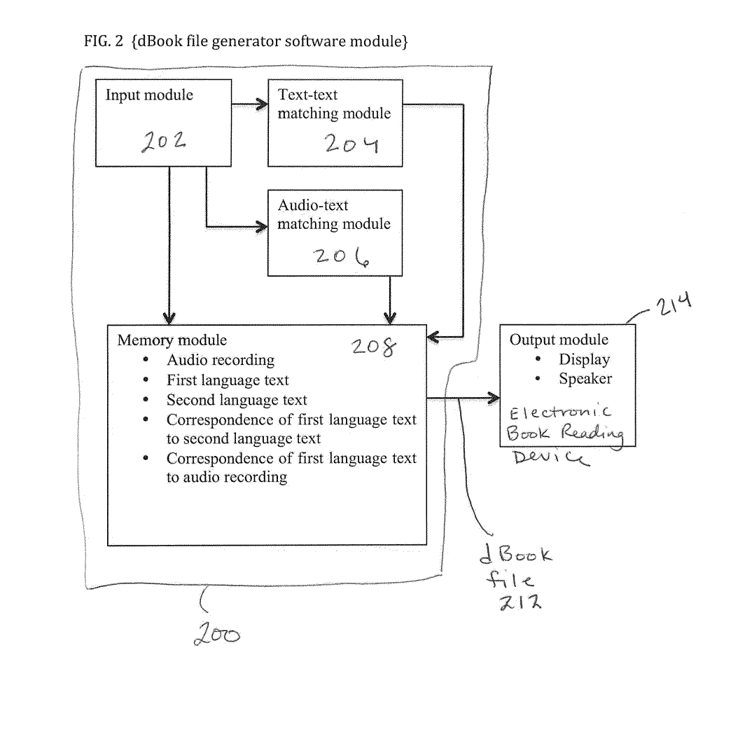

FIG. 2 is a block diagram of a software dual language electronic book generator module 200 that generates a dBook file for reading on an electronic book reading device, including a tablet computer such as an iPad™, a tablet running the Google™ Android™ operating system, a Nook™, Kindle™, or other portable computing device. Such a software dual language book generator may run, for example, on a personal computer or server.

The software module 200 includes an input module 202 that receives inputs such as a first language text, a second language text, an audio recording. The first and second language texts may involve simple text files. The audio recording may be in any format useable by an electronic book reading device, including for example, WAV, MPEG, MP3, and other commonly used uncompressed or compressed audio formats.

The software module 200 includes a text-text matching module 204 that, based on the first language text and the second language text, creates a correspondence between the first language text and the second language text by breaking each of the texts into a plurality of fragments, and matching fragments of the texts together based on a number of variables, as is described in further detail below. The correspondence between the first language text and the second language text may be stored in the memory module 208 in preparation of the dBook file 212.

The software module 200 includes a audio-text matching module 206 that, based on the first language text and the audio recording, creates a correspondence between original language text and the audio recording in the original language by breaking the audio recording into fragments and matching fragments of the first language text with fragments of the audio recording based on a number of variables, as is described in further detail below. The correspondence between original language text and the audio recording may be stored in the memory module 208 in preparation of the dBook file 212.

The software module 200 includes a memory module 208 that stores the inputs such as the first language text, the second language text, the audio recording, and one or more display variables. The memory module 208 may additionally store the generated dBook file 212 for output.

The software module 200 outputs a dBook file 212 (in the form of a downloadable file, file transmissible over wired or wireless network, or otherwise transferrable data file compatible for use in an electronic book reading device 214).

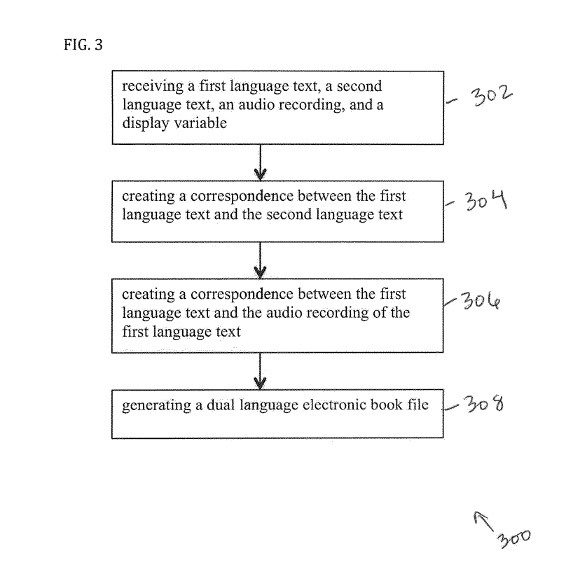

FIG. 3 is a flowchart of a method 300 for generation of a dual language electronic book file, in accordance with an embodiment of the present disclosure.

Text in the original language as well as the target language is provided. For example, files including the text in the two languages can be uploaded to a computer running the software module 200 of FIG. 2. In FIG. 3, the method includes receiving 302 a first language text, a second language text, and an audio recording.

The method further includes creating 304 a correspondence between the first language text and the second language text. For example, the correspondence may be generated when each of texts is broken down into “fragments.” For example, each fragment may represent a single sentence, but in the case of lines of dialog or short sentences, there may be more than one sentence per fragment. Breaking each text into fragments may be performed manually, for example, or, in a preferred embodiment, automatically by software, or by some combination of manual and automated means.

Each fragment in the original language for the text can be compared to fragments in the translated language and a score is assigned to each comparison indicating the similarity between the original language fragment and the translated language fragment, the score being indicative of the likelihood that the two fragments are corresponding fragments. Several variables are considered in calculating this score. These variables can include, but are not limited to, where the fragment occurs (i.e. proximity of the fragment to the start of the text), the length of the fragment (number of characters and number of words), the proportion of words in the original language fragment that have definitions that match the meaning of the words in the translated language fragment, the presence of punctuation such as question marks, quotation marks, and exclamation marks. The comparison with the highest score for each fragment is considered the “candidate match” for that fragment and is recorded. Forming “candidate matches” may be performed manually, for example, or, in a preferred embodiment, automatically by software.

The “candidate match” fragments may be displayed side by side. Optionally, a user with sufficient skill in both languages may make any necessary corrections. “Candidate match” fragments that were matched with a relatively low score, and therefore are less likely to be accurate matches, may optionally be highlighted to draw the user's attention to them. Once this process is complete, the fragments are considered “matched,” meaning that when the fragment is highlighted in the target language, the corresponding match in the native language will be highlighted, and the audible text in the target language will be played.

The method also extends to creating 306 a correspondence between original language text and the audio recording in the original language. The “matched” fragments, as described above, may be, in turn, tagged with audio timestamps to indicate the point in the audio recording at which they start being read. As before, the steps may be carried out automatically or manually by a human user, or by some combination of manual and automated means. The user imports an audio recording of the original language text being read aloud. The recording may be of any computer-playable format, including, but not limited, to mp3 format. The audio recording may be analyzed to match sections of the recording to corresponding sections of the original language text. Several variables are considered in the analyzing phase, for determining whether there is a “candidate tag” between a section in the audio recording and a section in the text. These variables may include, but are not limited to, where in the context of the entire text a fragment occurs, the length of the fragment, using voice recognition technology to analyze each word in the audio recording, the proportion of words that have definitions that match the meaning of the words in the translated language fragment, the tone of the recording and the corresponding presence in the text of punctuation such as question marks, quotation marks, and exclamation marks.

The “candidate tags” can be displayed. Optionally, a user with sufficient skill in both languages may make any necessary corrections. A display may be used to display a list of fragments in the text, while a user control interface is provided to enable the user (i.e., human) to control the audio recording (play, pause, stop, fast forward, etc.). If the user would like to overrule a candidate tagging, he or she can select a fragment, navigate to the location in the audio recording at which that fragment begins to be read, and press and a button that says “MATCH”. This associates the audio timestamp (for example, in a format of hh:mm:ss:ssss) with the fragment. These steps are iterated until each text fragment has an audio timestamp.

Based on the correspondence between the first language text and the second language text, as well as the correspondence between the first language text and the audio recording, the method includes generating 308 a dual language electronic book file. The dual language electronic book file can be read on any one of various electronic book reading devices commercially available to display text in both languages, highlighting in both a fragment of text in each language while the fragment of text in the target language is played audibly.

In order to display and play the text, the generated dual language electronic book file can be loaded to an electronic book reading device 214, for example, over a wireless or wired network connection from, for example, a server. The dual language electronic book file 212 can be opened and read by a user via a dBook reader application 424 running on the electronic book reading device 214. Execution of the dual language electronic book 212 by the dBook reader application 424 running on the electronic book reading device 214 can include calculating a number of fragments of the first language text and a number of fragments of the second language text to display based on a display variable. The dBook reader application 424 includes a display calculation module 428 that calculates how many fragments of both the original language text and the translated text will fit onto the screen of the particular electronic book reading device 214, taking into account display variable(s), such as hardware limitations such as size and resolution of the display, and any user entered options (such as font size and what portions of text are displayed) that have been selected.

Hardware display variables can include variables such as screen size, screen resolution, and other limitations of the particular hardware of the electronic book reading device. User entered display variables may include, for example, font size, whether a menu is shown or minimized in the page, whether the native language is shown or minimized in the page, and the like.

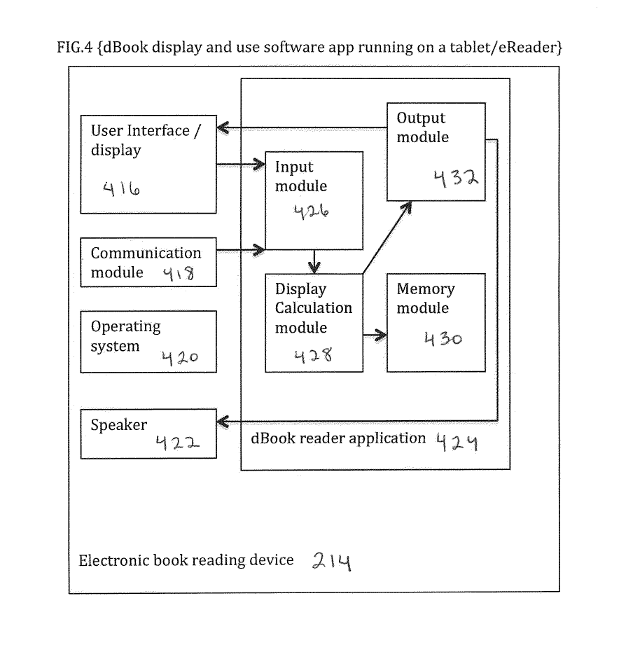

FIG. 4 shows a block diagram of an electronic book reading device 214 having a dBook reader application 424 running thereon. The electronic book reading device 213 includes, for example, a user interface/display 416, a communication module 418, an operating system 420, and a speaker 422. The dBook reader application 424 running on the electronic book reading device 214 includes an input module 426, a display calculation module 428, a memory module, 430 and an output module 432.

The communication module 418 is configured to upload/download a dual language electronic book file of the form generated by the method above. The communication module 418 may be configured for wireless or wired communication to/from another computer or service device, as is well known in the art. The user interface/display 416 can receive inputs from a user for a display variable. The user interface/display 416 can display the first language text and the second language text, for example, in a touch-sensitive screen. The speaker 422 is configured to audibly play at least a fragment of the audio recording of the first language text. The operating system 420 manages the hardware and software resources of the electronic book reading device 214, and enables the dBook reader application 424 to interact with the user interface/display 416 and the speaker 422.

The dBook reader application 424 is configured to, based on a display variable, calculate a number of fragments of the first language text and a number of fragments of the second language text to display on the user interface/display while the speaker audibly plays at least a fragment of the audio recording of the first language text, as described above.

The display calculation module 428 of the dBook reader application 424 is configured to re-calculate, and maximize the number of fragments of the first language text and the number of fragments of the second language text to display on the user interface/display 416 upon input by a user via the user interface/display 416 (such as, for example, turning a page, or changing one or more of the user entered display variables).

The input module 426 receives inputs in the form of the instruction-format list of fragments of text making up the dual language electronic book file, as well as any display variables, and passes the inputs to the display calculation module 428.

The memory module 430 may store, for example, any display variables (including user entered as well as hardware limitations) relevant to the electronic book reading device 214. The memory module 430 may also store, for example, one or more dual language electronic book files received over via the communication module 418.

The output module 432 passes executable instructions to the user interface/display 416 via the operating system 420 based on the calculation from the display calculation module 428 of what number of fragments of text from the first and second language texts can be displayed under the given limitations of the current hardware (i.e., that of the electronic book reading device 214 with the user entered display variables).

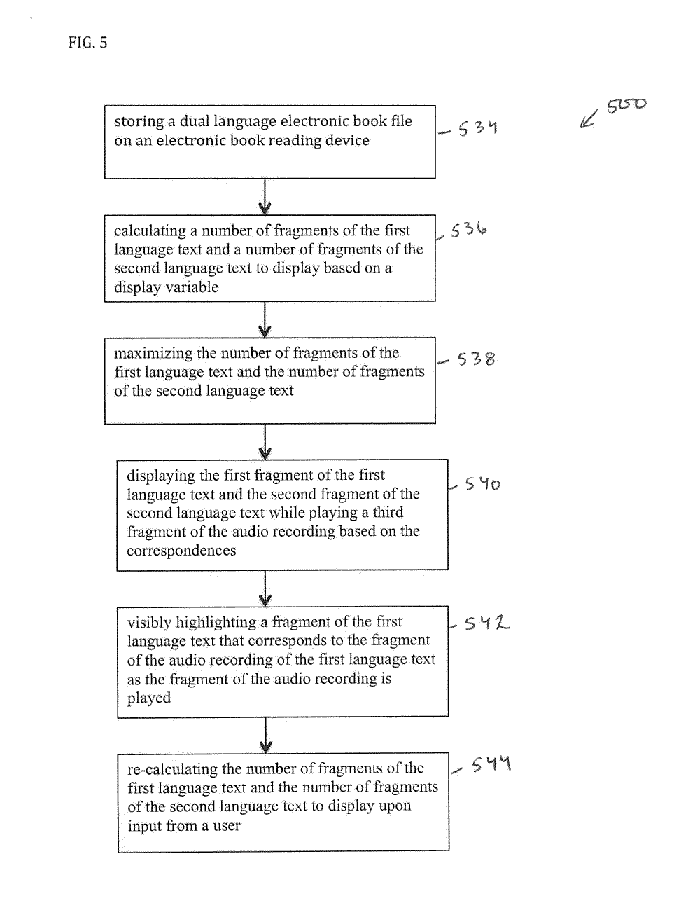

FIG. 5 is a flow chart of a method 500 for dual language electronic book education. The method includes storing 534 a dual language electronic book file on an electronic book reading device. For example, the dual language electronic book file can be downloaded over a wireless or wired connection to local storage on an electronic book reading device, such as a tablet computer running the dBook reader application.

The method further includes calculating 536 a number of fragments of the first language text and a number of fragments of the second language text to display based on a display variable. The calculating may be performed, for example, directly by the dBook reader application. The method further includes maximizing 538 the number of fragments of the first language text and the number of fragments of the second language text.

The method further includes displaying 540 the first fragment of the first language text and the second fragment of the second language text while playing a third fragment of the audio recording based on the correspondences on the user interface/display, as described above.

The method further includes visibly highlighting 542 a fragment of the first language text that corresponds to the fragment of the audio recording of the first language text as the fragment of the audio recording is played

The method further includes re-calculating 544 the number of fragments of the first language text and the number of fragments of the second language text to display upon input from a user. For example, the input from a user may include changing a display variable such as font size or font, or turning from one page to another in the dBook.

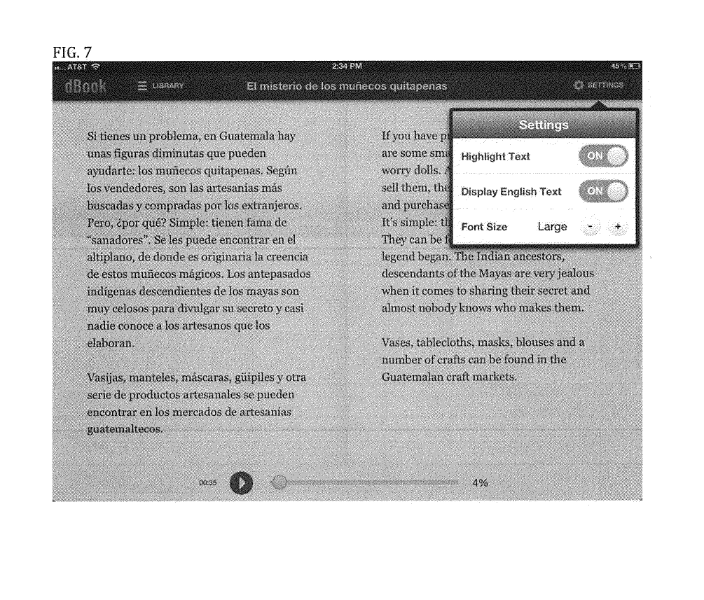

While viewing a dBook file in the dBook reader application, the user can customize various options, such as the font size and whether to display only the original language or both the original language and the translated language. FIG. 7 is a screenshot of customizable options in the user interface in the library of electronic dual language texts.

The dBook reader application can, in an embodiment, calculate how many fragments of both the original language text and the translated text will fit onto the screen of the portable computing device, taking into account variables including the size and resolution of the display and the options (such as font size) that have been selected. These fragments are displayed on the screen as the first page of the text. Each time the user navigates to another page in the text, or changes any of the options, the calculation may be performed again to maximize the number of fragments that can be rendered and displayed on the screen. The calculation may optionally be performed in advance, prior to a new page or pages being loaded, in order to improve performance.

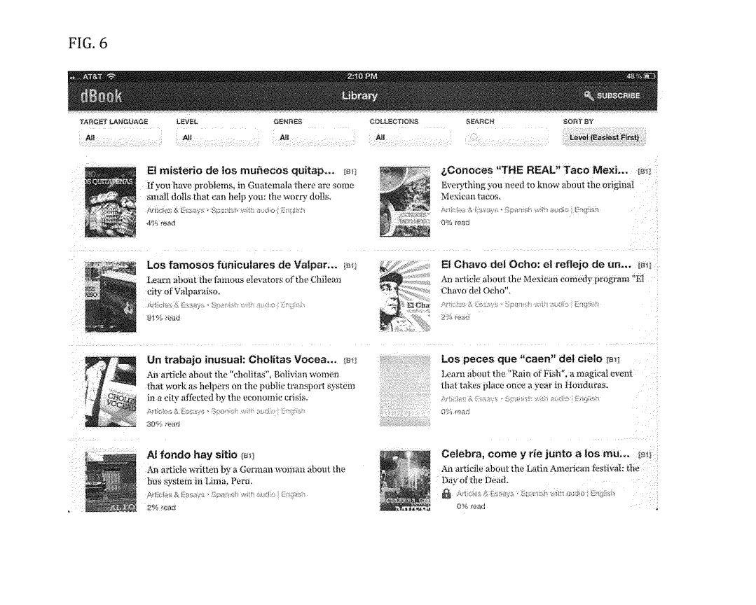

FIG. 6 is a screenshot of a library of electronic dual language texts available for reading and listening. In a library view, a user selects a text that he or she would like to read from a list of texts in the dBook Library.

FIG. 7 is a screenshot of customizable options in the user interface in the library of electronic dual language texts, as shown in FIG. 6. The user can customize various options, such as the font size and whether to display only the original language or both the original language and the translated language.

The terms “book” and/or “eBook” as used herein include electronic or digital representations of printed works, as well as digital content that may include text, multimedia, hypertext and/or hypermedia. Examples of printed and/or digital works include, but are not limited to, books, magazines, newspapers, periodicals, journals, reference materials, telephone books, textbooks, anthologies, instruction manuals, proceedings of meetings, forms, directories, maps etc. Accordingly, the terms book and/or eBook may include any content that is in electronic or digital format.

With such eBooks, the content may be structured as virtual frames presented on the device and a user may turn or change from one virtual frame or “page” of electronic content to another. It is further noted that various aspects and features described herein may be implemented in other electronic devices or electronic readers besides eBook reader devices including, for example, portable computers, personal digital assistants (PDAs), portable gaming devices, wireless phones, and the like.

While the examples described above have been detailed in the context of a tablet computer or eReader, the concepts described here are extendible to laptop or desktop computer, via display in a web browser or through a stand-alone software program, as well. Additionally, while a side-by-side reading of two languages is described, extending the concepts here to additional languages, for example for use in a multi-lingual classroom, is also envisioned.

Although a few example embodiments have been described in detail above, those skilled in the art will readily appreciate that many modifications are possible in the example embodiments without materially departing from this disclosure. Accordingly, such modifications are intended to be included within the scope of this disclosure as defined in the following claims. In the claims, means-plus-function clauses are intended to cover the structures described herein as performing the recited function and not simply structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

APPENDIX A

```
  <?xml version=“1.0” encoding=“UTF-8”?>
  <dbook version=“1.0”>
  <body>
  <fragment>
  <tuv xml:lang=“es”><seg>Bilbao, municipio situado en el norte de España, es la capital de Vizcaya,
  una de
las tres provincias de Euskadi (País Vasco). </seg></tuv>
  <tuv xml:lang=“en-US”><seg>Bilbao in northern Spain is the capital of Vizcaya, one of the three
provinces of the Basque Country (Pais Vasco). </seg></tuv>
  </fragment>
  <fragment>
  <tuv xml:lang=“es”><seg>Desde su fundación, hace más de 700 años, Bilbao ha sido el factor
  fundamental
en la modernización socio-económica de Vizcaya. </seg></tuv>
  <tuv xml:lang=“en-US”><seg>Since its foundation, more than 700 years ago, Bilbao has been the
fundamental factor in the socio-economic modernisation of Vizcaya. </seg></tuv>
  </fragment>
  <fragment>
  <tuv xml:lang=“es”><seg>Es la ciudad vasca más grande y animada y goza de un ambiente muy moderno.
</seg></tuv>
  <tuv xml:lang=“en-US”><seg>It is the largest and liveliest Basque city with very modern feel.
</seg></tuv>
  </fragment>
  </body>
```

What is claimed is:

1. A dual language electronic book generation method, comprising:
creating a correspondence between a first language text and a second language text;
creating a correspondence between the first language text and an audio recording of the first language text; and
generating a dual language electronic book file comprising the first language text, the second language text, the correspondence between the first language text and the second language text, and the correspondence between the first language text and the audio recording of the first language text.

2. The method according to claim 1, wherein creating a correspondence between the first language text and the second language text further comprises:
dividing the first language text and the second language text into a plurality of fragments;
comparing each fragment of the first language text to fragments of the second language text; and
defining a candidate match when, based on a plurality of variables, a fragment of the first language text and a fragment of the second language text linguistically correspond to each other.

3. The method according to claim 2, wherein the fragments comprise sentences.

4. The method according to claim 2, further comprising receiving a correction to the candidate match from a user or from a grammatical database.

5. The method according to claim 2, wherein creating a correspondence between the first language text and the audio recording of the first language text further comprises:
dividing the audio recording of the first language text into a plurality of fragments;
comparing each fragment of the first language text to fragments of the audio recording of the first language text; and
defining a candidate tag when, based on a plurality of variables, a fragment of the first language text and a fragment of the audio recording of the first language text linguistically correspond to each other.

6. The method according to claim 5, further comprising adding a time stamp to each fragment of the first language text identifying the fragment of the audio recording defined as the fragment's candidate tag.

7. The method according to claim 6, further comprising receiving a correction to the candidate tag from a user or from a grammatical database.

8. A dual language electronic book system platform, comprising:
an input module that receives a first language text, a second language text, and an audio recording of the first language text;
a text-text correspondence module that receives the first language text and second language text from the input module and outputs a correspondence between the first language text and the second language text; and
an audio-text correspondence module that receives the first language text and the audio recording of the first language text and outputs a correspondence between the first language text and the audio recording of the first language text; and
an output module that outputs a dBook file comprising the first language text, the second language text, the audio recording of the first language text; the correspondence between the first language text and the second language text, and the correspondence between the first language text and the audio recording of the first language text.

9. A method for dual language electronic book education, comprising:
storing a dual language electronic book file on an electronic book reading device, the dual language electronic book file comprising a first language text, a second language text, a correspondence between the first language text and the second language text, and a correspondence between the first language text and an audio recording of the first language text;
displaying a first fragment of the first language text adjacent to a second fragment of second language text based on the correspondence between the first language text and the second language text while playing a third fragment of the audio recording of the first language text based on the correspondence between the first language text and the audio recording of the first language text.

10. The method according to claim 9, further comprising based on a display variable comprising one or more of a hardware display variable and a user-entered display variable, calculating a number of fragments of the first language text and a number of fragments of the second language text to display.

11. The method according to claim 10, wherein the hardware display variable comprises one or more of screen size and screen resolution.

12. The method according to claim 10, wherein the user entered display variable comprises one or more of font size, a selection of a minimized menu or maximized menu, and a selection of whether the second language is maximized or minimized.

13. A electronic book reading device, comprising:
a communication module configured to upload a dual language electronic book file, the dual language electronic book file comprising a first language text, a second language text, a correspondence between the first language text and the second language text, and a correspondence between the first language text and an audio recording of the first language text;
a user interface/display configured to perform at least one of 1) receiving from a user a display variable, and 2) displaying the first language text and the second language text;
a speaker configured to audibly play at least a fragment of the audio recording of the first language text;
an operating system; and
an application configured to, based on a display variable comprising one or more of a hardware display variable and a user-entered display variable, calculate a number of fragments of the first language text and a number of fragments of the second language text to display on the user interface/display while the speaker audibly plays at least a fragment of the audio recording of the first language text.

14. The electronic book reading device according to claim 13, wherein the hardware display variable comprises one or more of screen size and screen resolution.

15. The electronic book reading device according to claim 13, wherein the user entered display variable comprises one or more of font size, a selection of a minimized menu or maximized menu, and a selection of whether the second language is maximized or minimized.

16. The electronic book reading device according to claim 13, wherein the application is further configured to visibly highlight a fragment of the first language text that corresponds to the fragment of the audio recording of the first language text as the fragment of the audio recording is played.

17. The electronic book reading device according to claim 13, wherein the application is further configured to re-calculate the number of fragments of the first language text and the number of fragments of the second language text to display on the user interface/display upon a user navigating to a second position in the first language text.

18. The electronic book reading device according to claim 13, wherein the application is further configured to maximize the number of fragments of the first language text and the number of fragments of the second language text to display on the user interface/display.

19. The electronic book reading device according to claim 15, wherein the application is further configured to re-calculate the number of fragments of the first language text and the number of fragments of the second language text to display on the user interface/display upon a user changing a user entered display variable.
